(19) United States
(12) Patent Application Publication
(10) Pub. No.: US 2021/0221694 A1
(43) Pub. Date: Jul. 22, 2021

(54) PROCESSES FOR MANUFACTURING A MATERIAL

(71) Applicant: Leonard Tim Sperry, III, Boca Raton, FL (US)

(72) Inventor: Leonard Tim Sperry, III, Boca Raton, FL (US)

(21) Appl. No.: 17/151,981

(22) Filed: Jan. 19, 2021

Related U.S. Application Data
(60) Provisional application No. 62/962,533, filed on Jan. 17, 2020.

(51) Int. Cl. C01B 39/02; B01D 53/02; B01F 3/12; B01F 15/00

(52) U.S. Cl. CPC C01B 39/026; B01D 53/02; B01F 3/1214; B01F 3/1271; B01D 2253/108; C01P 2004/61; B01F 2003/125; B01F 2215/0045; B01F 15/00363

(57) ABSTRACT

Disclosed herein is a process for manufacturing a material, in accordance with some embodiments. Accordingly, the material facilitates a reduction of pollutants from air. Further, the process may include heating natural zeolite to at least one hundred degree celsius for a predetermined duration of time. Further, the heating removes at least one impurity from the natural zeolite. Further, the process may include producing purified natural zeolite based on the heating. Further, the process may include grinding the purified natural zeolite into particles based on the producing. Further, the process may include incorporating the particles of the purified natural zeolite into a grind paste based on the grinding. Further, the incorporating produces the material.

The current application claims a priority to the U.S. Provisional Patent application Ser. No. 62/962,533 filed on Jan. 17, 2019. The current application is filed on Jan. 19, 2021 while Jan. 17, 2021 was on a weekend and Jan. 18, 2021 was on a national holiday (Martin Luther King Jr. Day).

### FIELD OF THE INVENTION

Generally, the present disclosure relates to the field of hazardous or toxic waste destruction or containment. More specifically, the present disclosure relates to processes for manufacturing a material and providing the material with air purifying and carbon dioxide absorbing properties.

### BACKGROUND OF THE INVENTION

Typically, an average person spends about 90 percent of their time indoors and is constantly surrounded by painted surfaces. Furthermore, most of the paint used is toxic or contains toxic ingredients that can be harmful after constant exposure. So, the average person is not only exposed to harmful airborne toxins but also the constant airborne pollutants contained indoors.

Therefore, there is a need for improved processes for manufacturing a material with active air purifying properties to eliminate indoor and outdoor airborne pollutants that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a process for manufacturing a material, in accordance with some embodiments. Accordingly, the material facilitates a reduction of pollutants from air. Further, the process may include heating natural zeolite to at least one hundred degree celsius for a predetermined duration of time. Further, the heating removes at least one impurity from the natural zeolite. Further, the process may include producing purified natural zeolite based on the heating. Further, the process may include grinding the purified natural zeolite into particles based on the producing. Further, the process may include incorporating the particles of the purified natural zeolite into a grind paste based on the grinding. Further, the incorporating produces the material.

Further disclosed herein is a material composition for producing a material, in accordance with some embodiments. Further, the material facilitates a reduction of pollutants from air. Further, the material composition may include purified natural zeolite present in an amount ranging from 1% to 15% or more depending on a type of the material by weight based on the total weight of the material composition. Further, the purified natural zeolite allows adsorbing of the pollutants from the air. Further, the pollutants may be airborne. Further, the material composition may include a grind paste allowing manufacturing of at least a portion of at least one object using the material by at least one manufacturing process. Further, at least one object may be configured for reducing the pollutant from the air.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a flow chart of a process for manufacturing a material, in accordance with some embodiments.

FIG. 2 is a flow chart of a process for adding pigments for manufacturing the material, in accordance with some embodiments.

FIG. 3 is a flow chart of a method for facilitating purification and enhancement of natural zeolite, in accordance with some embodiments.

FIG. 4 is a flowchart of a method for facilitating production of a mixture, in accordance with some embodiments.

FIG. 5 is a tabular representation associated with the material composition of the material, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of processes for manufacturing a material, embodiments of the present disclosure are not limited to use only in this context.

Overview:

The present disclosure describes processes for manufacturing a material. Further, the present disclosure describes a material composition for producing the material. Further, the material may include air purifying and carbon dioxide absorbing properties. Further, the present disclosure describes a mixture that may include a natural mineral known as zeolite. Further, the present disclosure describes a method for the production of environmentally friendly architectural paint. Further, the architectural paint may eliminate indoor and outdoor airborne pollutants, and carbon dioxide. Furthermore, the preparation, purification, and enhancement of zeolite are required to be incorporated into the mixture. Therefore, a method of purification is presented as well as a method of production for the mixture thereof. The mixture may include titanium dioxide as a white pigment, which acts as a photocatalyst when in contact with the solar light. Further, order for the incorporation of the different ingredients of the mixture is provided as well. Furthermore, different quantities of zeolites in the mixture provide varying levels of air purifying properties in the paint.

The mixture (or the material) may include ingredients whose effects lead to purifying the air by adsorbing, absorbing, or binding gaseous air pollutants to them. The mixture may include several ingredients that may be shared amongst most non-toxic paint, but also comprises the presence of a mineral known as zeolite and titanium dioxide. Since the zeolite is naturally a negatively charged mineral, the zeolite allows for the air purification process to occur by attracting, adsorbing, and reducing carbon dioxide particles, volatile organic compounds, and other gaseous airborne pollutants. Natural zeolites functions as a molecular sieve that have properties to adsorbs, absorbs, or binds gaseous chemicals and pollutants to its natural structure. Furthermore, titanium dioxide is a white pigment that comprises photocatalyst properties when in contact with the sunlight. In alternate embodiments, the titanium dioxide may not be present in the mixture. Zeolite is an aluminum silicate that exists naturally and may also be produced synthetically. Further, the mixture may include natural zeolite.

The mixture may purify the air from indoor airborne pollutants. Furthermore, the mixture may be nontoxic, contains zero volatile organic compounds, and eliminates odors. The mixture may be contained in eco-packaging and is not tested on animals

Further, the mixture may include zeolites from a domestic mine. In order to incorporate zeolites into a paint mixture (or the mixture), a method is required. This enables the use of the zeolites such that they can safely be mixed with the other ingredients for the formula of the disclosed mixture. Furthermore, the method ensures that naturally occurring impurities from the zeolite are desorbed. The method ensures that the zeolite may yield maximum efficiency to eliminate airborne pollutants.

The paint mixture may be applied like other architectural paint as a coating on interior or exterior surfaces. Once the mixture is applied to a surface, after it completely dries the zeolite, the active negatively charged mineral in the paint starts to attract positively charged ions and adsorb them. Further, the mixture may adsorb, absorb, or bind CO2, VOCs, and other specific airborne pollution to it.

Further, in an embodiment, the mixture may include clinoptilolite zeolite, chabazite that may be a tectosilicate mineral of zeolite group, or any other species of natural zeolite. Further, the mixture may include at least one of natural types of zeolite. Further, the zeolite as a molecular sieve may be configured for adsorbing CO2, VOC, and noxious odors (gaseous air contaminants).

Further, the mixture may include an enhanced zeolite, such as ZEO CarbonTech™

“Zeolite is an aluminium silicate which exists naturally and is also produced synthetically. The zeolite has a three-dimensional structure with pores. It consists of silicon, aluminium and oxygen ions. The silicon ions are neutrally-loaded in the crystal structure. The aluminium ions cause negative areas to exist. In order to keep the load balanced, a cation (Na+, K+ . . . ) or a proton (H+) is placed in the pores as a counter-ion.

Each zeolite type has equal-sized pores throughout the entire crystal structure. The crystal structure is partly determined by the crystal structure's ring size. Altering the ratio between aluminium and silicon can have an impact on the pore size as well as the counter-ion. All natural zeolites contain aluminium and are hydrophilic. These materials form a good absorbent for polar substances (e.g. water and water-soluble substances). When the aluminium is removed, the zeolite becomes hydrophobic and is able to adsorb apolar substances like VOC's.

Hydrophobic zeolites can be synthetically manufactured in the form of crystals with a diameter of 1 μm to 1 mm These crystals are bound together into larger grains, in order to reduce the bed's air-resistance. Because synthetic zeolites are expensive compared to natural zeolites, they are normally only used as hydrophobic zeolites or zeolite catalysts.

Similarly to activated carbon, zeolites are also used in a bed. The adsorption principle in the bed and the saturation of the bed are the same as activated carbon adsorption.

In contrast to activated carbon, zeolite is not only used once and destroyed after saturation, but used in zeolite regeneration applications. This is due to the zeolite's cost aspects (see technique sheet 19 for an explanation about regeneration).

Zeolite does not have a linear adsorption curve. In other words, adsorption capacity is not reduced greatly for low VOC concentrations. It is thus more suitable for working with low end concentrations than activated carbon or polymer.

Zeolites can be obtained with pore sizes between 0.3-3 nm. This pore size is uniform for one type of zeolite. A zeolite will not adsorb molecules that are larger than the pore size. Molecules without an affinity will also not be adsorbed.

Variants

Zeolites can be used together with activated carbon, whereby the polymer or activated carbon operate at higher concentrations and the zeolite as polishing for lower concentrations. This can be performed in various beds stage-by-stage or via a mixture of adsorbents that form one bed.

Efficiency

The efficiency is determined by:
type of zeolite
type of VOC
Flue gas temperature
Flue gas humidity
For odour, yields of 80-95% can be realized.

Boundary conditions
Flow rate: <100 000 m³/h
Temperature: <250° C.
Concentration: <25% of lowest explosion limit

Zeolites are less sensitive to moisture than activated carbon, less susceptible to reactions that could lead to spontaneous combustion in the bed, and are slower to pulverize. If a bed fire should occur, there will not be a problem if the temperature remains below the zeolite's transition temperature. If the temperature should exceed this level, then the pore size of the zeolite will decrease, whereby the adsorption properties will change. In this case, it may be necessary to replace part of the zeolite. In most cases, the temperature will remain below the transition temperature if one blows sufficient air through the filter. If this is case, only the solvent will burn.

Auxiliary Materials

The zeolite seldom needs to be replaced in regenerative applications (regenerative sorption). The guarantee provided by the supplier lasts for 5 years. Apolar zeolites are, due to their price, normally not used for once-only applications.

Environmental Aspects

Occasionally it is necessary to dispose of run-down zeolites (https://emis.vito.be/en/techniekficheizeolite-adsorption).

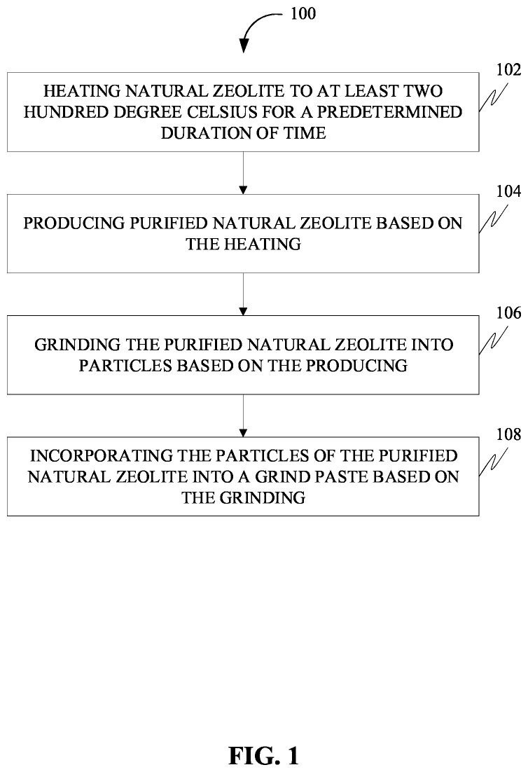

Referring now to figures, FIG. 1 is a flow chart of a process 100 for manufacturing a material, in accordance with some embodiments. Accordingly, the material facilitates a reduction of carbon dioxide and pollutants from air. Further, at 102, the process 100 may include heating natural zeolite to at least one hundred degree Celsius for a predetermined duration of time. Further, the heating removes at least one impurity from the natural zeolite. Further, the heating the natural zeolite may enhance ability of the natural zeolite to adsorb toxic air pollutants and carbon dioxide.

Further, at 104, the process 100 may include producing purified natural zeolite (or purified and enhanced natural zeolite) based on the heating.

Further, at 106, the process 100 may include grinding the purified natural zeolite into particles based on the production.

Further, at 108, the process 100 may include incorporating the particles of the purified natural zeolite into a grind paste based on the grinding. Further, the incorporating produces the material with air purifying and carbon dioxide adsorbing properties.

Further, in some embodiments, the heating may include increasing a temperature of the natural zeolite by a heating rate for the predetermined duration of time. Further, the heating rate may be one degree Celsius per minute.

Further, in some embodiments, the grind paste may include at least one of titanium dioxide, clay, ceramic, and water.

Further, in some embodiments, the titanium dioxide allows catalyzing of the adsorbing of the pollutants from the air based on receiving sunlight. Further, the reduction of the pollutants from the air may be based on the catalyzing.

Further, in some embodiments, the grinding may include sizing the particles of the purified natural zeolite to a size. Further, the size of the particles ranges from 1 micron to 40 microns.

Further, in an embodiment, the material may include chabazite. Further, the chabazite may be a tectosilicate mineral of zeolite group.

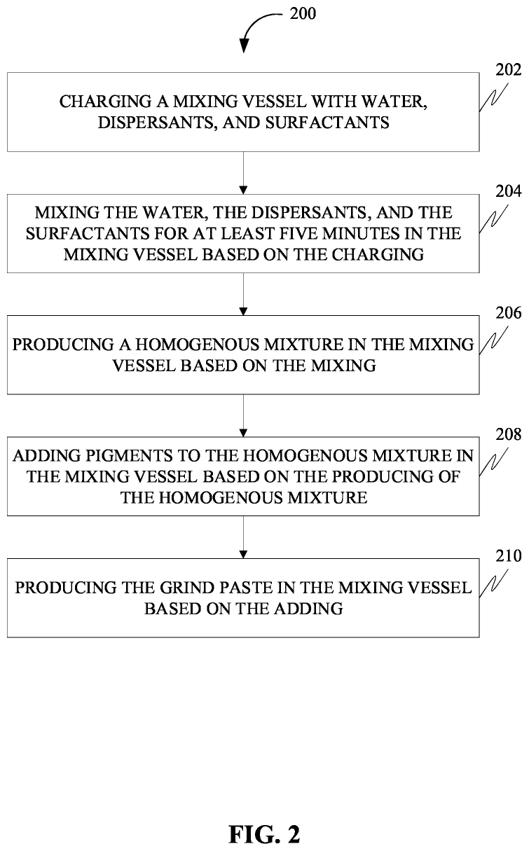

FIG. 2 is a flow chart of a process 200 for adding pigments for manufacturing the material, in accordance with some embodiments. Accordingly, at 202, the process 200 may include charging a mixing vessel with water, dispersants, and surfactants.

Further, at 204, the process 200 may include mixing the water, the dispersants, and the surfactants for at least five minutes in the mixing vessel based on the charging.

Further, at 206, the process 200 may include producing a homogenous mixture in the mixing vessel based on the mixing.

Further, at 208, the process 200 may include adding pigments to the homogenous mixture in the mixing vessel based on the producing of the homogenous mixture.

Further, at 210, the process 200 may include producing the grind paste in the mixing vessel based on the adding. Further, the incorporating of the particles of the purified natural zeolite may be based on the producing of the grind paste.

Further, in some embodiments, the process 200 may include adding resin, defoamers, and at least one rheological additive into the mixing vessel based on the producing of the grind paste and the incorporating the particles of the purified natural zeolite. Further, the adding of the resin, the defoamers, and the at least one rheological additive produces the material.

In further embodiments, a material composition for producing a material is disclosed, in accordance with some embodiments. Accordingly, the material facilitates a reduction of pollutants from air. Further, the material composition may include purified natural zeolite present in an amount ranging from 1% to 15% or more depending on a type of the material by weight based on the total weight of the material composition. Further, the purified natural zeolite allows adsorbing of the pollutants from the air. Further, the pollutants may be airborne. Further, the material composition may include a grind paste allowing manufacturing of at least a portion of at least one object using the material by at least one manufacturing process. Further, the at least one object may be configured for reducing the pollutant from the air.

Further, in an embodiment, the purified natural zeolite may be present in an amount ranging greater than 1% by weight based on the total weight of the material composition.

Further, in an embodiment, the purified natural zeolite may be present in an amount ranging greater than 1.73% and less than 10% by weight based on the total weight of the material composition.

Further, in an embodiment, the purified natural zeolite may be present in an amount ranging from 1.73% to 15% by weight based on the total weight of the material composition.

Further, in an embodiment, for cardboard/paper integration, the purified natural zeolite may be present in an amount ranging from 5% to 25% by weight based on the total weight of the material composition.

Further, in an embodiment, for usage in an architectural paint, the purified natural zeolite may be present in an amount ranging 10% or more by weight based on the total weight of the material composition.

Further, in some embodiments, the at least one manufacturing process may include a painting process. Further, the material may be applied on at least one surface of the at least one object in the painting process for the manufacturing of the at least the portion of the at least one object.

Further, in some embodiments, the at least one manufacturing process may include a molding process. Further, the material may be molded in the at least the portion of the at least one object in the molding process for the manufacturing of the at least the portion of the at least one object.

Further, in some embodiments, the grind paste may include titanium dioxide, clay, ceramic, and water.

Further, in some embodiments, the titanium dioxide of the grind paste allows catalyzing of the adsorbing of the pollutants from the air based on receiving sunlight. Further, the reducing of the pollutant from the air may be based on the catalyzing.

Further, in some embodiments, the material may be associated with at least one color. Further, the purified natural zeolite provides the at least one color to the material based on the amount ranging from the purified natural zeolite.

Further, in some embodiments, the purified natural zeolite may include particles. Further, a size of the particles ranges from 1 micron to 40 microns.

In further embodiments, the material composition may include the dispersants.

In further embodiments, the material composition may include the surfactants.

In further embodiments, the material composition may include pigment.

In further embodiments, the material composition may include the resin.

In further embodiments, the material composition may include the defoamers.

In further embodiments, the material composition may include the at least one rheological additive.

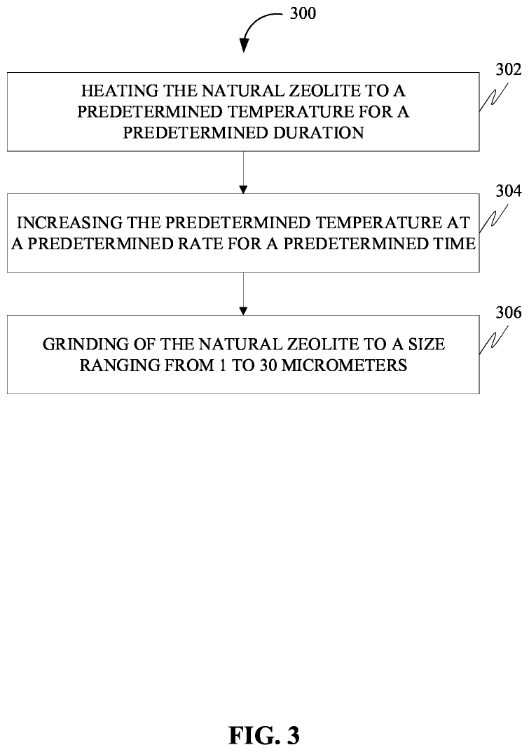

FIG. 3 is a flow chart of a method 300 for facilitating purification and enhancement of natural zeolite, in accordance with some embodiments. Accordingly, at 302, the method 300 may include heating the natural zeolite to a predetermined temperature for a predetermined duration. Further, the predetermined temperature may be 200 degrees Celsius or more. Further, the predetermined duration maybe 4 hours.

Further, at 304, the method 300 may include increasing the predetermined temperature at a predetermined rate for a predetermined time. Further, the predetermined rate may be 1 degree Celsius per minute. Further, the heating of the natural zeolite may desorb naturally accumulated impurities from the natural zeolite that may ensure the natural zeolite has reached maximum efficiency for adsorption purposes. Further, the elimination of the impurities from the natural zeolite allows for maximum reduction of airborne pollutants upon incorporation of the natural zeolite into a mixture. Further, in an embodiment, the predetermined temperature may range from 120 degree celsius to 350 degree celsius. Further, the impurities, such as CO₂, may be fully desorbed at 350 degree celsius. Further, the predetermined duration may range from 5 minutes to 30 minutes.

Further, at 306, the method 300 may include grinding of the natural zeolite to a size ranging from 1 to 30 micrometers. Further, the natural zeolite may be incorporated into a grind paste comprising water, titanium dioxide, clay, and ceramic.

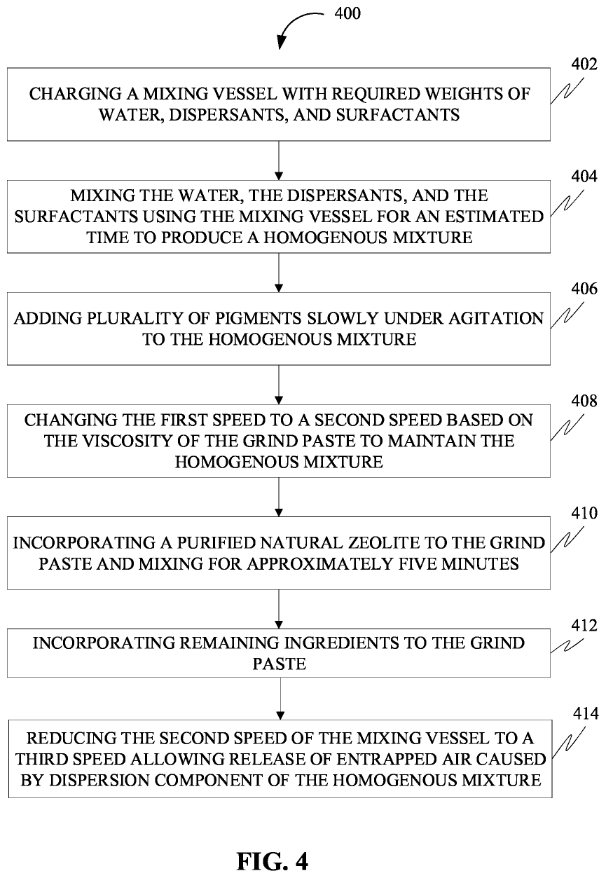

FIG. 4 is a flowchart of a method 400 for facilitating production of a mixture, in accordance with some embodiments. Accordingly, at 402, the method 400 may include charging a mixing vessel with required weights of water, dispersants, and surfactants. Further, at 404, the method 400 may include mixing the water, the dispersants, and the surfactants using the mixing vessel for an estimated time to produce a homogenous mixture. Further, the estimated time may be 5 minutes.

Further, at 406, the method 400 may include adding a plurality of pigments slowly under agitation to the homogenous mixture. Further, the agitation may be associated with a first speed. Further, the agitation results in a grind paste. As more pigments of the plurality of pigments are incorporated into the homogenous mixture, a viscosity of the grind paste increases.

Further, at 408, the method 400 may include changing the first speed to a second speed based on the viscosity of the grind paste to maintain the homogenous mixture. Further, this is denoted as the dispersion component of the homogenous mixture for a batch.

Further, at 410, the method 400 may include incorporating a purified natural zeolite to the grind paste and mixing for approximately five minutes.

Further, at 412, the method 400 may include incorporating remaining ingredients to the grind paste. The remaining ingredients may include resin, defoamers, and any other rheological additives.

Further, at 414, the method 400 may include reducing the second speed of the mixing vessel to a third speed allowing release of entrapped air caused by dispersion component (or portion) of the homogenous mixture.

Further, the homogenous mixture may include different quantities of natural zeolite based on a shade of the specified color. For instance, a mixture for a lighter color paint may include around a quarter pound of natural zeolite. If more natural zeolite is added, then the lighter color paint may result in a yellow tint due to a natural color of the zeolite. Meanwhile, a darker color may include a higher quantity of natural zeolite since the yellow tint may not affect the final color.

Further, in an instance, upon application of the grind paste on a surface, the surface may be heated at a temperature ranging from 120 degree celsius to 350 degree celsius. Further, temperature for heating the surface may be increased after heating for 5 minutes to 30 minutes. Further, the temperature may be increased at a predetermined rate. Further, the impurities (such as the CO₂) that may be adsorbed by the grind paste may be fully desorbed at 350 degree celsius. Further, the desorbing of the impurities may result enhancing adsorption efficiency of the grind paste.

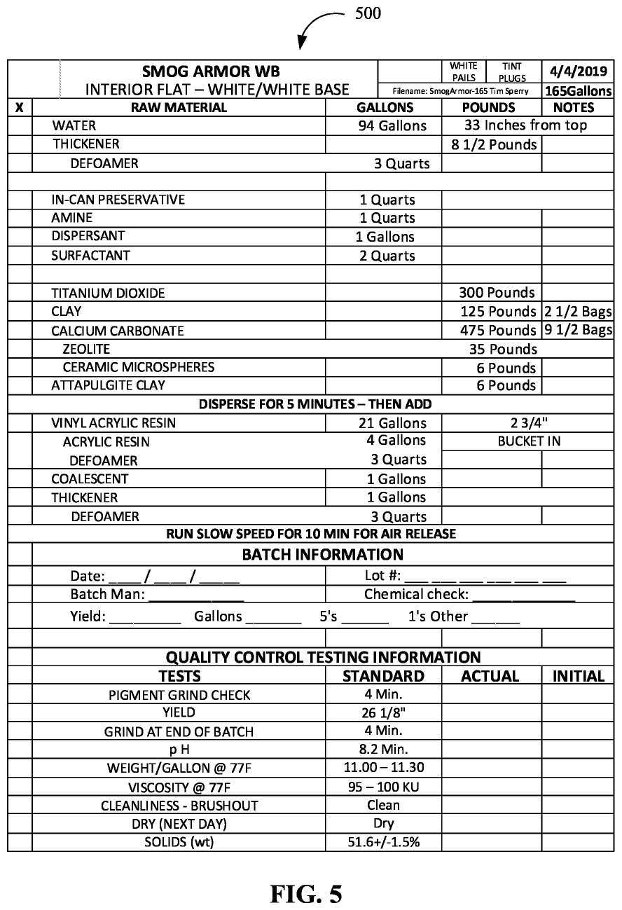

FIG. 5 is a tabular representation 500 associated with the material composition of the material, in accordance with some embodiments. Accordingly, in an instance, a total volume of the material may be 165 gallons. Further, raw materials may be dispersed for 5 minutes to form a mixture. Further, raw materials may include water, thickener, defoamer, in-can preservative, amine, dispersant, surfactant, titanium dioxide, clay, calcium carbonate, zeolite, ceramic microspheres, and attapulgite clay. Further, the water may be 94 gallons. Further, the thickener may be 8½ pounds. Further, the defoamer may be 3 quartz. Further, the in-can preservative may be 1 quartz. Further, the amine may be 1 quartz. Further, the dispersant may be 1 gallon. Further, the surfactant may be 2 quartz. Further, the titanium dioxide may be 300 pounds. Further, the clay may be 125 pounds. Further, the calcium carbonate may be 475 pounds. Further, the zeolite may be 35 pounds. Further, the ceramic microspheres may be 6 pounds. Further, the attapulgite clay may be 6 pounds. Further, vinyl acrylic resin may be added to the mixture in an amount that may be 21 gallons. Further, acrylic resin may be added to the mixture in an amount that may be 4 gallons. Further, defoamer may be added to the mixture in an amount that may be 3 quartz. Further, coalescent may be added to the mixture in an amount that may be 1 gallon. Further, thickener may be added to the mixture in an amount that may be 1 gallon. Further, the mixture may be run at a slow speed for 10 minutes for air release for manufacturing the material.

Further, the material may be quality checked based on quality control testing information. Further, the quality control testing information may include one or more tests.

Further, the one or more tests may include pigment grind check, yield, grind at end of batch, pH test, weight/gallon @77F, viscosity @77F, cleanliness—brushout, dry (next day), and solids (wt.). Further, each of the one or more tests may be associated with a standard value. Further, a standard value associated with the pigment grind check may be 4 min. Further, a standard value associated with the yield may be 26⅛″. Further, a standard value associated with the grind at end of batch may be 4 min. Further, a standard value associated with the pH may be 8.2 min. Further, a standard value associated with the weight/gallon @77F may be 11.00-11.30. Further, a standard value associated with the viscosity @77F may be 95-100 KU. Further, a standard value associated with the cleanliness—brushout may be “clean”. Further, a standard value associated with the dry (next day) may be “dry”. Further, a standard value associated with the solids (wt.) may be 51.6+/−1.5%.

Although the present disclosure has been explained in relation to its preferred embodiment, it is to be understood that many other possible modifications and variations can be made without departing from the spirit and scope of the disclosure.

What is claimed is:

1. A material composition for producing a material, wherein the material facilitates a reduction of pollutants from air, wherein the material composition comprises:
purified natural zeolite present in an amount ranging from 1% to 15% or more depending on a type of the material by weight based on the total weight of the material composition, wherein the purified natural zeolite allows adsorbing of the pollutants from the air, wherein the pollutants is airborne; and
a grind paste allowing manufacturing of at least a portion of at least one object using the material by at least one manufacturing process, wherein the at least one object is configured for reducing the pollutant from the air.

2. The material composition of claim 1, wherein the at least one manufacturing process comprises a painting process, wherein the material is applied on at least one surface of the at least one object in the painting process for the manufacturing of the at least the portion of the at least one object.

3. The material composition of claim 1, wherein the at least one manufacturing process comprises a molding process, wherein the material is molded in the at least the portion of the at least one object in the molding process for the manufacturing of the at least the portion of the at least one object.

4. The material composition of claim 1, wherein the grind paste comprises at least one of titanium dioxide, clay, ceramic, and water.

5. The material composition of claim 4, wherein the titanium dioxide of the grind paste allows catalyzing of the adsorbing of the pollutants from the air based on receiving sunlight, wherein the reducing of the pollutant from the air is based on the catalyzing.

6. The material composition of claim 1, wherein the material is associated with at least one color, wherein the purified natural zeolite provides the at least one color to the material based on the amount ranging from the purified natural zeolite.

7. The material composition of claim 1, wherein the purified natural zeolite comprises particles, wherein a size of the particles ranges from 1 micron to 40 microns.

8. The material composition of claim 1 further comprises dispersants.

9. The material composition of claim 1 further comprises surfactants.

10. The material composition of claim 1 further comprises pigment.

11. The material composition of claim 1 further comprises resin.

12. The material composition of claim 1 further comprises defoamers.

13. The material composition of claim 1 further comprises at least one rheological additive.

14. A process for manufacturing a material, wherein the material facilitates a reduction of pollutants from air, wherein the process comprises:
heating natural zeolite to at least one hundred degree celsius for a predetermined duration of time, wherein the heating removes at least one impurity from the natural zeolite;
producing purified natural zeolite based on the heating;
grinding the purified natural zeolite into particles based on the producing; and
incorporating the particles of the purified natural zeolite into a grind paste based on the grinding, wherein the incorporating produces the material.

15. The process of claim 14, wherein the heating comprises increasing a temperature of the natural zeolite by a heating rate for the predetermined duration of time, wherein the heating rate is one degree Celsius per minute.

16. The process of claim 14 further comprising:
charging a mixing vessel with water, dispersants, and surfactants;
mixing the water, the dispersants, and the surfactants for at least five minutes in the mixing vessel based on the charging;
producing a homogenous mixture in the mixing vessel based on the mixing;
adding pigments to the homogenous mixture in the mixing vessel based on the producing of the homogenous mixture; and
producing the grind paste in the mixing vessel based on the adding, wherein the incorporating of the particles of the purified natural zeolite is further based on the producing of the grind paste.

17. The process of claim 16 further comprising adding resin, defoamers, and at least one rheological additive into the mixing vessel based on the producing of the grind paste and the incorporating the particles of the purified natural zeolite, wherein the adding of the resin, the defoamers, and the at least one rheological additive produces the material.

18. The process of claim 14, wherein the grind paste comprises titanium dioxide, clay, ceramic, and water.

19. The process of claim 18, wherein the titanium dioxide allows catalyzing of the adsorbing of the pollutants from the air based on receiving sunlight, wherein the reduction of the pollutants from the air is based on the catalyzing.

20. The process of claim 14, wherein the grinding comprising sizing the particles of the purified natural zeolite to a size, wherein the size of the particles ranges from 1 micron to 40 microns.
